(19) United States
(12) Patent Application Publication
(10) Pub. No.: US 2026/0114356 A1
(43) Pub. Date: Apr. 30, 2026

(54) ROW UNIT LIFT CONTROL SYSTEM FOR AN AGRICULTURAL SEEDING IMPLEMENT

(71) Applicant: CNH Industrial Canada, Ltd., Saskatoon (CA)

(72) Inventors: Trevor Lawrence Kowalchuk, Saskatoon (CA); Nicholas George Alfred Ryder, Saskatoon (CA)

(21) Appl. No.: 18/930,271

(22) Filed: Oct. 29, 2024

(51) Int. Cl. A01C 7/08; A01C 7/20

(52) U.S. Cl. CPC A01C 7/08; A01C 7/201

(57) ABSTRACT

A row unit lift control system for an agricultural seeding implement includes a controller having a processor and a memory. The controller is configured to determine a forward speed differential between a left forward speed of one or more left row units positioned at a left portion of a frame of the agricultural seeding implement and a right forward speed of one or more right row units positioned at a right portion of the frame of the agricultural seeding implement. The controller is also configured to control at least one actuator of the agricultural seeding implement to lift a slower of the one or more left row units or the one or more right row units in response to determining the forward speed differential is greater than a threshold forward speed differential.

### BACKGROUND

The present disclosure relates to a row unit lift control system for an agricultural seeding implement.

Generally, seeding implements (e.g., seeders) are towed behind a tractor or other work vehicle. Seeding implements typically include multiple row units distributed across a width of the seeding implement. In certain seeding implements, each row unit is configured to deposit agricultural product (e.g., seed and/or fertilizer) at a target depth beneath the soil surface of a field, thereby establishing rows of planted agricultural product. For example, each row unit may include an opener that forms a trench for agricultural product deposition into the soil. An agricultural product tube (e.g., positioned adjacent to the opener) is configured to deposit agricultural product into the trench. In addition, the opener and the agricultural product tube may be followed by a packer wheel that packs the soil on top of the deposited agricultural product.

### BRIEF DESCRIPTION

In certain embodiments, a row unit lift control system for an agricultural seeding implement includes a controller having a processor and a memory. The controller is configured to determine a forward speed differential between a left forward speed of one or more left row units positioned at a left portion of a frame of the agricultural seeding implement and a right forward speed of one or more right row units positioned at a right portion of the frame of the agricultural seeding implement. The controller is also configured to control at least one actuator of the agricultural seeding implement to lift a slower of the one or more left row units or the one or more right row units in response to determining the forward speed differential is greater than a threshold forward speed differential.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural seeding implement having multiple row units;

FIG. 2 is a side view of an embodiment of a row unit that may be employed within the agricultural seeding implement of FIG. 1; and

FIG. 3 is a block diagram of an embodiment of a row unit lift control system that may be employed within the agricultural seeding implement of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

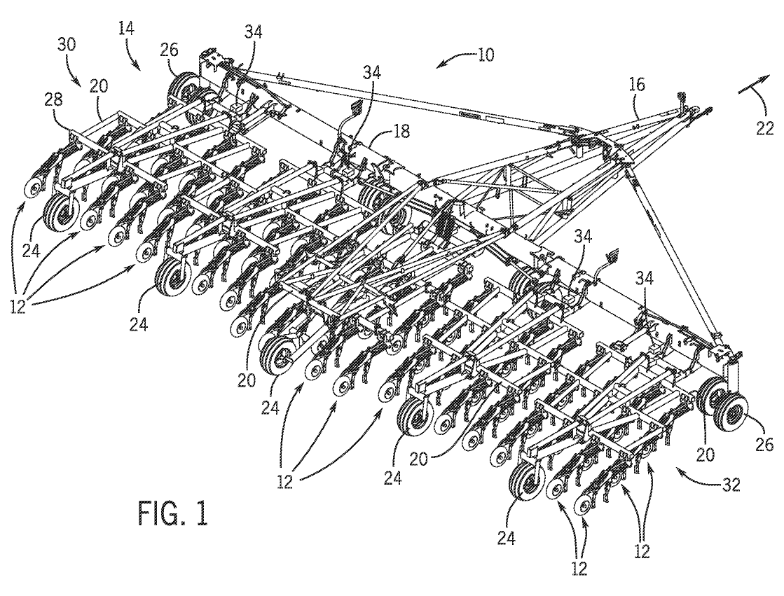

FIG. 1 is a perspective view of an embodiment of an agricultural seeding implement 10 (e.g., seeder) having multiple row units 12. In the illustrated embodiment, the agricultural seeding implement 10 includes a frame 14 having a hitch assembly 16, a main support bar 18, and tool frames 20. The hitch assembly 16 is configured to couple to a hitch of a work vehicle (e.g., a tractor) to enable the work vehicle to move the agricultural seeding implement 10 along a direction of travel 22. The hitch assembly 16 is coupled to the main support bar 18, and the main support bar 18 is coupled to the tool frames 20. As illustrated, each tool frame 20 is supported by a respective wheel 24, and the main support bar 18 is supported by multiple wheels 26. In certain embodiments, each tool frame is pivotally coupled to the main support bar to enable the tool frame to follow contours of the soil surface. However, in other embodiments, each tool frame is rigidly (e.g., non-rotatably) coupled to the main support bar (e.g., such that the tool frames and the main support bar form a unitary structure). Furthermore, while the frame 14 includes five tool frames 20 in the illustrated embodiment, in other embodiments, the frame may include more or fewer tool frames (e.g., 1, 2, 3, 4, 6, 7, 8, 9, 10, or more).

In the illustrated embodiment, each row unit 12 is coupled to a toolbar 28 of a respective tool frame 20 and configured to deposit agricultural product within the soil. In certain embodiments, the row units 12 are laterally offset (e.g., offset in a direction perpendicular to the direction of travel 22) from one another, such that adjacent rows of agricultural product are established within the soil. While the agricultural seeding implement frame 14 includes the main support bar 18 and the tool frames 20 in the illustrated embodiment, in other embodiments, the frame may include other and/or additional elements to support the row units. For example, in certain embodiments, the main support bar may be omitted, a center tool frame may be coupled to the hitch assembly, and wing tool frames may be coupled to the center tool frame. Furthermore, in certain embodiments, the tool frames may be omitted, and the row units may be directly coupled to the main support bar (e.g., toolbar), thereby forming a single row of row units.

In certain embodiments, each row unit 12 of the agricultural seeding implement 10 includes an opener that forms a trench for agricultural product deposition into the soil. An agricultural product tube, which may be positioned adjacent to the opener, is configured to deposit agricultural product into the trench. The opener and the agricultural product tube are followed by a packer wheel that packs soil on top of the deposited agricultural product. In certain embodiments, each row unit includes a depth control system configured to control a position of the packer wheel relative to the opener to control the penetration depth of the opener within the soil.

In certain embodiments, the agricultural seeding implement includes a row unit lift control system configured to automatically lift at least a portion of the row units 12, thereby disengaging the row unit(s) from the soil. As discussed in detail below, the row unit lift control system includes a controller having a processor and a memory. The controller is configured to determine a forward speed differential between a left forward speed of one or more left row units 12 positioned at a left portion 30 of the frame 14 and a right forward speed of one or more right row units 12 positioned at a right portion 32 of the frame 14. In addition, the controller is configured to control at least one actuator of the agricultural seeding implement 10 to lift a slower of the one or more left row units or the one or more right row units in response to determining the forward speed differential is greater than a threshold forward speed differential. For example, during a left turn, the right portion 32 of the frame 14 may have a higher ground speed than the left portion 30 of the frame 14, and during a right turn, the left portion 30 of the frame 14 may have a higher ground speed than the right portion 32 of the frame 14. Furthermore, during a tight left turn, the left portion 30 of the frame 14 may move rearwardly relative to the soil, and during a tight right turn, the right portion 32 of the frame 14 may move rearwardly relative to the soil. Accordingly, to substantially reduce or eliminate the possibility of the openers of the left row units moving rearwardly through the soil during a tight left turn, and to substantially reduce or eliminate the possibility of the openers of the right row units moving rearwardly through the soil during a tight right turn, the controller is configured to control the actuator(s) to lift the slower of the left row unit(s) or the right row unit(s) in response to determining the forward speed differential is greater than the threshold forward speed differential. As a result, the load(s) (e.g., the rearward load and/or the side load) on the openers may be reduced, thereby increasing the longevity of the openers. In addition, the possibility of the agricultural product tubes filling with soil may be substantially reduced or eliminated.

In certain embodiments, the actuator(s) configured to lift the row unit(s) include tool frame actuators 34. In the illustrated embodiment, each tool frame 20 is pivotally coupled to the main support bar 18, and a tool frame actuator 34 is coupled to the tool frame 20 and to the main support bar 18. Each tool frame actuator 34 is configured to drive the tool frame 20 to rotate relative to the main support bar 18 between the illustrated working position and a raised transport position. In addition, each tool frame actuator 34 may include any suitable type of actuation device, such as a hydraulic cylinder, a pneumatic cylinder, and electric linear actuator, an electric motor, a hydraulic motor, a pneumatic motor, etc. In response to determining the forward speed differential is greater than the threshold forward speed differential, the controller may control at least one of the tool frame actuators 34 to lift the respective tool frame(s) 20 from the illustrated working position to the raised transport position. For example, during a tight left turn, the controller may determine the forward speed differential is greater than the threshold forward speed differential, and the left forward speed of the left row units at the left portion 30 of the frame 14 is less than the right forward speed of the right row units at the right portion 32 of the frame 14. In response, the controller may control the tool frame actuator 34 coupled to the leftmost tool frame 20 to lift the leftmost tool frame 20 from the illustrated working position to the raised transport position, thereby disengaging the openers of the row units 12 coupled to the leftmost tool frame 20 from the soil. Furthermore, during a tight right turn, the controller may determine the forward speed differential is greater than the threshold forward speed differential, and the right forward speed of the right row units at the right portion 32 of the frame 14 is less than the left forward speed of the left row units at the left portion 30 of the frame 14. In response, the controller may control the tool frame actuator 34 coupled to the rightmost tool frame 20 to lift the rightmost tool frame 20 from the illustrated working position to the raised transport position, thereby disengaging the openers of the row units 12 coupled to the rightmost tool frame 20 from the soil. While a single tool frame actuator 34 is coupled to each tool frame 20 in the illustrated embodiment, in other embodiments, multiple tool frame actuators may be coupled to at least one tool frame, and the controller may control the tool frame actuator(s) coupled to each tool frame to control the position of the tool frame.

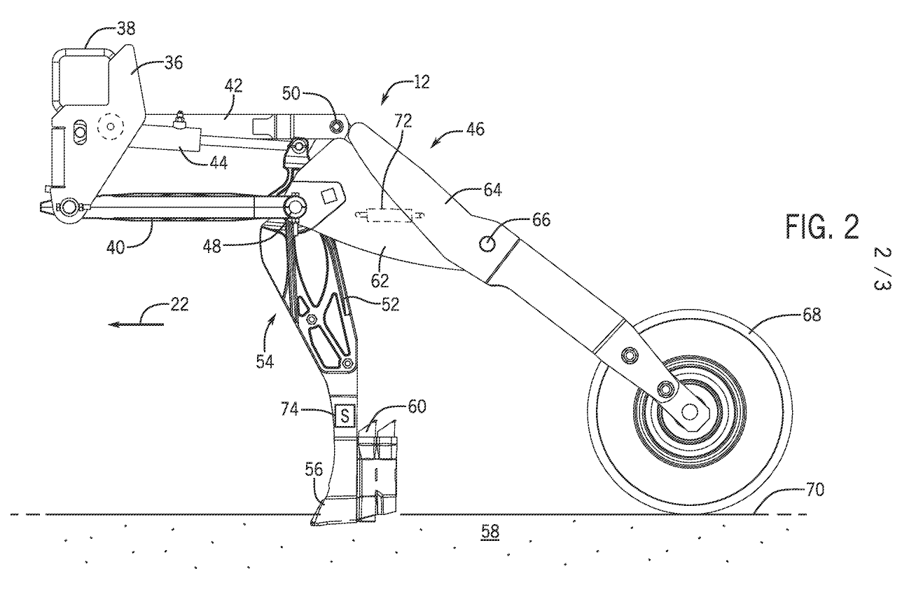

FIG. 2 is a side view of an embodiment of a row unit 12 that may be employed within the agricultural seeding implement of FIG. 1. As illustrated, the row unit 12 includes a frame support 36 and a mounting bracket 38. The frame support 36 and the mounting bracket 38 are configured to interface with a toolbar (e.g., of a respective tool frame), thereby securing the row unit 12 to the frame of the agricultural seeding implement. While the row unit 12 includes a single mounting bracket 38 in the illustrated embodiment, in other embodiments, the row unit may include multiple mounting brackets (e.g., 2, 3, 4, 5, 6, or more). Furthermore, while the row unit 12 is coupled to the toolbar by the frame support 36 and the mounting bracket(s) 38 in the illustrated embodiment, in other embodiments, the row unit may be coupled to the toolbar by any other suitable connection system (e.g., including fastener(s), a welded connection, an adhesive connection, etc.).

In addition, in the illustrated embodiment, the row unit 12 includes a first linkage member 40, a second linkage member 42, and a biasing device, such as the illustrated row unit downforce actuator 44. As illustrated, the first linkage member 40 (e.g., first link) and the second linkage member 42 (e.g., second link) extend from the frame support 36 to a packer wheel arm assembly 46. The first linkage member 40 is pivotally coupled to the frame support 36, thereby pivotally coupling the first linkage member 40 to the toolbar of the agricultural seeding implement. In addition, the first linkage member 40 is pivotally coupled to the packer wheel arm assembly 46 at a first pivot joint 48. In the illustrated embodiment, the second linkage member 42 is pivotally coupled to the frame support 36, thereby pivotally coupling the second linkage member 42 to the toolbar of the agricultural seeding implement. Furthermore, the second linkage member 42 is pivotally coupled to the packer wheel arm assembly 46 at a second pivot joint 50. Accordingly, the first and second linkage members form a linkage (e.g., parallel linkage) between the frame support 36 and the packer wheel arm assembly 46. While the linkage is formed by the first and second linkage members in the illustrated embodiment, in other embodiments, the packer wheel arm assembly may be coupled to the frame support by any other suitable type of linkage (e.g., a linkage including only the first linkage member, a linkage including only the second linkage member, etc.).

The row unit downforce actuator 44 is pivotally coupled to the frame support 36 and to a shank 52 of an opener 54 of the row unit 12. In addition, the shank 52 is pivotally coupled to the first linkage member 40 and to the packer wheel arm assembly 46 at the first pivot joint 48. A blade 56 of the opener 54 is rigidly coupled (e.g., non-movably coupled, non-rotatably coupled, non-translatably coupled, etc.) to the shank 52 and configured to engage the soil 58. The row unit downforce actuator 44 is configured to urge the packer wheel arm assembly 46 and the opener 54 to translate downwardly. Translational movement of the packer wheel arm assembly 46 and the opener 54 is controlled by the linkage. For example, the linkage may cause the packer wheel arm assembly 46 and the opener 54 to translate with respect to a vertical axis. The row unit downforce actuator 44 may include any suitable type(s) of actuation device(s), such as hydraulic cylinder(s), pneumatic cylinder(s), etc. Furthermore, while the biasing device includes the row unit downforce actuator 44 in the illustrated embodiment, in other embodiments, the row unit may include other suitable type(s) of biasing device(s), such as a spring or a pneumatic strut.

The blade 56 is configured to form a trench within the soil 58 as the row unit 12 moves along the direction of travel 22. In the illustrated embodiment, the row unit 12 includes an agricultural product tube 60 (e.g., seed tube) configured to direct agricultural product into the trench formed by the blade 56. In the illustrated embodiment, the row unit 12 includes two agricultural product tubes 60 configured to deposit two agricultural products (e.g., two different agricultural products) into the soil. However, in other embodiments, the row unit may include more or fewer agricultural product tubes (e.g., 1, 3, 4, or more).

In the illustrated embodiment, the packer wheel arm assembly 46 includes a base 62 and a packer wheel arm 64 pivotally coupled to one another at a third pivot joint 66. The base 62 is pivotally coupled to the first linkage member 40 and to the second linkage member 42, and a packer wheel 68 is rotatably coupled to the packer wheel arm 64 of the packer wheel arm assembly 46. The packer wheel 68 rotates along a surface 70 of the soil 58 to both pack the soil on top of deposited agricultural product and to control the penetration depth of the blade 56. In the illustrated embodiment, the row unit 12 includes a packer wheel actuator 72 (e.g., depth control system) coupled to the base 62 and to the packer wheel arm 64 of the packer wheel arm assembly 46. The packer wheel actuator 72 is configured to control a position of the packer wheel 68 relative to the opener 54 to control the penetration depth of the blade 56 within the soil 58. For example, the packer wheel actuator 72 may drive the packer wheel arm 64 to rotate upwardly relative to the base 62 of the packer wheel arm assembly 46, thereby moving the packer wheel 68 upwardly relative to the opener 54. The force applied by the row unit downforce actuator 44 may enable the packer wheel 68 to maintain contact with the surface 70 as the packer wheel 68 moves upwardly relative to the opener 54, thereby causing the penetration depth of the blade 56 to increase. In addition, the packer wheel actuator 72 may drive the packer wheel arm 64 to rotate downwardly relative to the base 62 of the packer wheel arm assembly 46, thereby moving the packer wheel 68 downwardly relative to the opener 54. The force applied by the row unit downforce actuator 44 may enable the packer wheel 68 to maintain contact with the surface 70 as the packer wheel 68 moves downwardly relative to the opener 54, thereby causing the penetration depth of the blade 56 to decrease.

While the packer wheel actuator 72 is positioned proximate to the linkage members in the illustrated embodiment, in other embodiments, the packer wheel actuator may be positioned proximate to the packer wheel or at another suitable location along the packer wheel arm assembly. Furthermore, while the row unit 12 includes the packer wheel actuator 72 in the illustrated embodiment, in other embodiments, the row unit may include another suitable depth control system, such as a fastener/slot assembly, a fastener/apertures assembly, a rotating cam assembly, a mechanical stop/slide assembly, etc. In addition, while the opener 54 includes a single shank 52 in the illustrated embodiment, in other embodiments, the opener may include multiple shanks. For example, in certain embodiments, the opener may include a second shank and a second blade coupled to the second shank, in which the second shank is coupled (e.g., pivotally coupled) to the base of the packer wheel arm assembly. Furthermore, in certain embodiments, the row unit may include a single arm pivotally coupled to the frame support, in which the single arm forms the shank of the opener (e.g., the blade of the opener is rigidly coupled to the single arm). In such embodiments, the row unit downforce actuator may be pivotally coupled to the frame support and to the single arm, and the packer wheel arm may be pivotally coupled to the single arm (e.g., the single arm may form the base of the packer wheel arm assembly).

As previously discussed, in certain embodiments, the agricultural seeding implement includes a row unit lift control system configured to automatically lift at least a portion of the row units 12, thereby disengaging the row unit(s) from the soil. As discussed in detail below, the row unit lift control system includes a controller having a processor and a memory. The controller is configured to determine a forward speed differential between a left forward speed of one or more left row units 12 positioned at a left portion of the frame of the agricultural seeding implement and a right forward speed of one or more right row units 12 positioned at a right portion of the frame of the agricultural seeding implement. In addition, the controller is configured to control at least one actuator of the agricultural seeding implement to lift a slower of the one or more left row units or the one or more right row units in response to determining the forward speed differential is greater than a threshold forward speed differential. As a result, the possibility of openers 54 of the row units 12 moving rearwardly through the soil 58 is substantially reduced or eliminated. Accordingly, the load(s) (e.g., the rearward load and/or the side load) on the openers 54 may be reduced, thereby increasing the longevity of the openers 54. In addition, the possibility of the agricultural product tube filling with soil may be substantially reduced or eliminated.

In certain embodiments (e.g., in embodiments in which each tool frame is rigidly coupled to the main support bar), the actuator(s) of the row unit lift control system include the row unit downforce actuators 44 of at least certain row units. In response to determining the forward speed differential is greater than the threshold forward speed differential, the controller may control the row unit downforce actuator 44 of at least one row unit 12 to lift the opener 54 of each respective row unit 12, such that the blade 56 of the opener 54 disengages the soil 58. For example, during a tight left turn, the controller may determine the forward speed differential is greater than the threshold forward speed differential, and the left forward speed of left row unit(s) at the left portion of the frame of the agricultural seeding implement is less than the right forward speed of right row unit(s) at the right portion of the frame of the agricultural seeding implement. In response, the controller may control the row unit downforce actuator 44 of each row unit of the left row unit(s) to lift the respective opener(s) 54, such that the blade(s) 56 disengage the soil 58. Furthermore, during a tight right turn, the controller may determine the forward speed differential is greater than the threshold forward speed differential, and the right forward speed of right row unit(s) at the right portion of the frame of the agricultural seeding implement is less than the left forward speed of left row unit(s) at the left portion of the frame of the agricultural seeding implement. In response, the controller may control the row unit downforce actuator 44 of each row unit of the right row unit(s) to lift the respective opener(s) 54, such that the blade(s) 56 disengage the soil 58.

Furthermore, in certain embodiments, the controller is configured to determine a side load on the opener 54 of at least one row unit 12. In addition, the controller is configured to control actuator(s) to lift the at least one row unit in response to determining the side load is greater than a threshold side load. In the illustrated embodiment, the row unit lift control system includes a force sensor 74 coupled to the shank 52 of the opener 54 and communicatively coupled to the controller. The force sensor 74 is configured to output a force signal indicative of the side load applied to the opener 54 (e.g., the shank 52 of the opener 54), and the controller is configured to receive the force signal and to determine the side load based on the feedback from the force sensor 74. The force sensor 74 may include any suitable type of force sensing device, such as a strain gauge, a load cell, etc. The controller may determine the side load on the opener 54 based on feedback from the force sensor 74, and the controller may control the row unit downforce actuator 44 to lift the opener 54, such that the blade 56 disengages the soil 58, in response to determining the side load is greater than the threshold side load. As a result, the side load on the opener 54 may be reduced, thereby increasing the longevity of the opener 54. The process of determining the side load and selectively lifting the opener may be performed for each row unit of the agricultural seeding implement. While the force sensor 74 is coupled to the shank 52 of the opener 54 in the illustrated embodiment, in other embodiments, the force sensor may be coupled to the blade of the opener or to any other suitable component of the opener (e.g., to the second shank of the opener in embodiments in which the opener includes two shanks). Furthermore, while the controller is configured to control the row unit downforce actuator 44 to lift the opener 54 in the illustrated embodiment, in other embodiments, the controller may control a respective tool frame actuator to lift the row unit in response to determining the side load is greater than the threshold side load.

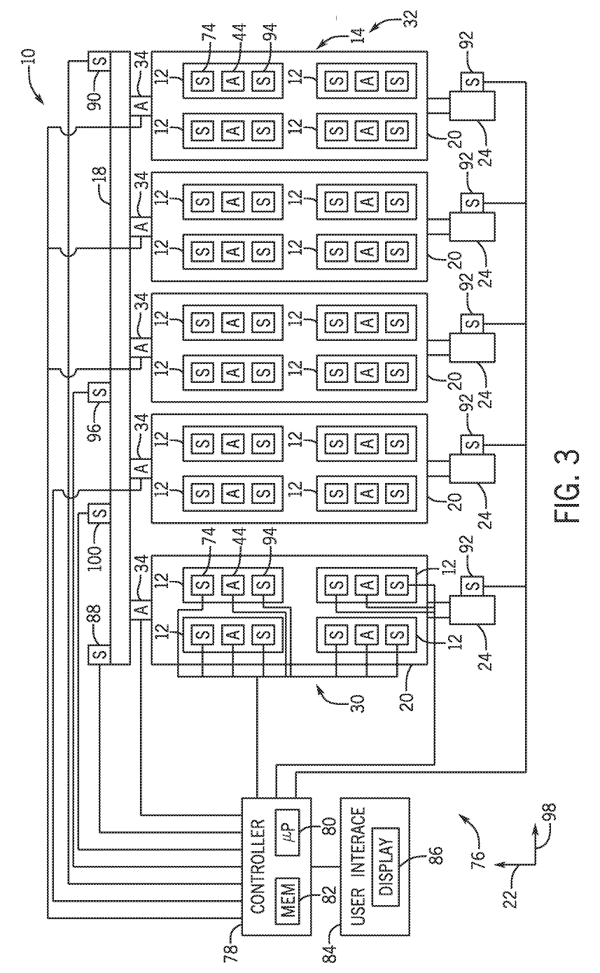

FIG. 3 is a block diagram of an embodiment of a row unit lift control system 76 that may be employed within the agricultural seeding implement of FIG. 1. In the illustrated embodiment, the row unit lift control system 76 includes the tool frame actuators 34. As previously discussed, each tool frame 20 is pivotally coupled to the main support bar 18, and a tool frame actuator 34 is coupled to each tool frame 20 and to the main support bar 18. Each tool frame actuator 34 is configured to drive the tool frame 20 to rotate relative to the main support bar 18 between the working position and the raised transport position. With the tool frame in the raised transport position, the row units coupled to the tool frame are disengaged from the soil. Furthermore, in the illustrated embodiment, the row unit lift control system 76 includes the row unit downforce actuators 44 of the row units 12. As previously discussed, each downforce actuator 44 is configured to lift the opener of the respective row unit 12, such that the blade of the opener disengages the soil. As used herein with regard to lifting each row unit, “lift” refers to raising at least the opener of the row unit, such that the blade of the opener disengages the soil. For example, lifting the row unit may include lifting the entire row unit (e.g., via the tool frame actuator), such that the blade of the opener and the packer wheel disengage the soil, and lifting the opener (e.g., via the row unit downforce actuator), such that the blade of the opener disengages the soil.

In the illustrated embodiment, the row unit lift control system 76 includes a controller 78 communicatively coupled to the tool frame actuators 34 (e.g., directly, via valve blocks in embodiments in which the tool frame actuators include hydraulic cylinders, etc.) and to the row unit downforce actuators 44 (e.g., directly, via valve blocks in embodiments in which the row unit downforce actuators include hydraulic cylinders, etc.). In FIG. 3, certain connections between row unit downforce actuators 44 and the controller 78 are not shown for clarity. In certain embodiments, the controller 78 is an electronic controller having electrical circuitry configured to control the tool frame actuators 34 and the row unit downforce actuators 44. In the illustrated embodiment, the controller 78 includes a processor, such as the illustrated microprocessor 80, and a memory device 82. The controller 78 may also include one or more storage devices and/or other suitable components. The processor 80 may be used to execute software, such as software for controlling the tool frame actuators 34 and the row unit downforce actuators 44, and so forth. Moreover, the processor 80 may include multiple microprocessors, one or more “general-purpose” microprocessors, one or more special-purpose microprocessors, and/or one or more application specific integrated circuits (ASICs), or some combination thereof. For example, the processor 80 may include one or more reduced instruction set (RISC) processors.

The memory device 82 may include a volatile memory, such as random access memory (RAM), and/or a nonvolatile memory, such as read-only memory (ROM). The memory device 82 may store a variety of information and may be used for various purposes. For example, the memory device 82 may store processor-executable instructions (e.g., firmware or software) for the processor 80 to execute, such as instructions for controlling the tool frame actuators 34 and the row unit downforce actuators 44, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the tool frame actuators 34 and the row unit downforce actuators 44, etc.), and any other suitable data.

In the illustrated embodiment, the row unit lift control system 76 includes a user interface 84 communicatively coupled to the controller 78. The user interface 84 is configured to receive input from an operator and to provide information to the operator. The user interface 84 may include any suitable input device(s) for receiving input, such as a keyboard, a mouse, button(s), switch(es), knob(s), other suitable input device(s), or a combination thereof. In addition, the user interface 84 may include any suitable output device(s) for presenting information to the operator, such as speaker(s), indicator light(s), other suitable output device(s), or a combination thereof. In the illustrated embodiment, the user interface 84 includes a display 86 configured to present visual information to the operator. In certain embodiments, the display 86 may include a touchscreen interface configured to receive input from the operator.

In the illustrated embodiment, the controller 78 is configured to determine a forward speed differential between a left forward speed of one or more left row units 12 positioned at the left portion 30 of the frame 14 and a right forward speed of one or more right row units 12 positioned at the right portion 32 of the frame 14. In addition, the controller 78 is configured to control at least one actuator of the agricultural seeding implement 10 (e.g., one or more tool frame actuators 34 and/or one or more row unit downforce actuators 44) to lift a slower of the one or more left row units or the one or more right row units in response to determining the forward speed differential is greater than a threshold forward speed differential. As used herein, “slower” refers to the lower of the left forward speed or the right forward speed. For example, during a left turn, the right portion 32 of the frame 14 may have a higher forward speed than the left portion 30 of the frame 14, and during a right turn, the left portion 30 of the frame 14 may have a higher forward speed than the right portion 32 of the frame 14. Furthermore, during a tight left turn, the left portion 30 of the frame 14 may move rearwardly relative to the soil, and during a tight right turn, the right portion 32 of the frame 14 may move rearwardly relative to the soil. Accordingly, to substantially reduce or eliminate the possibility of the openers of the left row units moving rearwardly through the soil during a tight left turn, and to substantially reduce or eliminate the possibility of the openers of the right row units moving rearwardly through the soil during a tight right turn, the controller 78 is configured to control the actuator(s) (e.g., the tool frame actuator(s) 34 and/or the row unit downforce actuator(s) 44) to lift the slower of the left row unit(s) or the right row unit(s) in response to determining the forward speed differential is greater than the threshold forward speed differential. As a result, the rearward load on the openers may be reduced, thereby increasing the longevity of the openers. In addition, the possibility of the agricultural product tube filling with soil may be substantially reduced or eliminated.

In certain embodiments, the threshold forward speed differential may be represented as a speed, such as in km/h (e.g., 1 km/h, 2 km/h, 3 km/h, 4 km/h, 5 km/h, 6 km/h, etc.). Furthermore, in certain embodiments, the threshold forward speed differential may be represented as a percentage of a forward speed of the agricultural seeding implement (e.g., an average of the left forward speed and the right forward speed, a forward speed of a lateral center of the agricultural seeding implement, the speed of the agricultural seeding implement along the direction of travel 22, etc.), such as 80 percent, 60 percent, 50 percent, 40 percent, 30 percent, 20 percent, etc. In addition, in certain embodiments, the controller 78 may be configured to control the at least one actuator to lift the slower of the one or more left row units or the one or more right row units in response to determining the forward speed differential is greater than the threshold forward speed differential and the forward speed of the agricultural implement is less than a threshold minimum speed (e.g., 10 km/h, 8 km/h, 6 km/h, 5 km/h, 4 km/h, etc.).

In the illustrated embodiment, the row unit lift control system 76 includes a left speed sensor 88 communicatively coupled to the controller 78 and a right speed sensor 90 communicatively coupled to the controller 78. The left speed sensor 88 is configured to monitor the left forward speed and to output a sensor signal to the controller 78 indicative of the left forward speed. In addition, the right speed sensor 90 is configured to monitor the right forward speed and to output a sensor signal to the controller 78 indicative of the right forward speed. The controller 78 is configured to determine the forward speed differential based on feedback from the left speed sensor 88 and the right speed sensor 90 (e.g., by determining the difference between the left forward speed and the right forward speed).

In certain embodiments, at least one of the left speed sensor 88 or the right speed sensor 90 (e.g., each of the left speed sensor 88 and the right speed sensor 90) includes an accelerometer configured to monitor acceleration (e.g., along a direction of movement of the respective portion of the frame 14 of the agricultural seeding implement 10). The controller 78 may determine the forward speed (e.g., the left forward speed or the right forward speed) by repeatedly sampling the acceleration at time intervals. Furthermore, in certain embodiments, at least one of the left speed sensor 88 or the right speed sensor 90 (e.g., each of the left speed sensor 88 and the right speed sensor 90) includes an inertial measurement unit (IMU) configured to monitor the position and velocity of the respective portion of the frame 14 of the agricultural seeding implement 10 based on linear and/or angular acceleration(s). In addition, in certain embodiments, at least one of the left speed sensor 88 or the right speed sensor 90 (e.g., each of the left speed sensor 88 and the right speed sensor 90) includes a spatial locating device (e.g., global positioning system (GPS) receiver, etc.). The spatial locating device is configured to monitor the position and velocity of the respective portion of the frame 14 of the agricultural seeding implement 10 based on signals from spatial locating (e.g., GPS) satellites. With regard to the IMU and the spatial locating device, the controller 78 may determine the forward speed (e.g., the left forward speed or the right forward speed) based on the velocity of the respective portion of the frame 14.

Furthermore, in certain embodiments, at least one of the left speed sensor 88 or the right speed sensor 90 (e.g., each of the left speed sensor 88 and the right speed sensor 90) includes a wheel speed sensor configured to monitor the forward speed of the frame 14 of the agricultural seeding implement 10 at the location of a respective wheel. As previously discussed, each tool frame 20 is supported by a respective wheel 24. In certain embodiments, a wheel speed sensor 92 may be configured to monitor the rotational speed of each wheel 24. As illustrated, each wheel speed sensor 92 is communicatively coupled to the controller 78. Each wheel speed sensor 92 is configured to monitor the rotational speed of the respective wheel 24, and the controller 78 is configured to determine the forward speed of the frame 14 at the location of the respective wheel 24 based on the wheel rotation speed and the diameter of the respective wheel 24. For example, the wheel speed sensor 92 that monitors the wheel 24 supporting the leftmost tool frame 20 may correspond to the left speed sensor, which is configured to monitor the left forward speed, and the wheel speed sensor 92 that monitors the wheel 24 supporting the rightmost tool frame 20 may correspond to the right speed sensor, which is configured to monitor the right forward speed. As previously discussed, the controller 78 is configured to determine the forward speed differential based on feedback from the left speed sensor and the right speed sensor (e.g., by determining the difference between the left forward speed and the right forward speed). Furthermore, in certain embodiments, the controller 78 may determine the forward speed of the agricultural seeding implement 10 (e.g., along the direction of travel 22) based on feedback from the wheel speed sensor 92 coupled to the wheel 24 that supports the center tool frame 20. While a wheel speed sensor 92 is configured to monitor the wheel rotation speed of each wheel 24 that supports a respective tool frame 20 in the illustrated embodiment, in other embodiments, the row unit lift control system may only include a wheel speed sensor configured to monitor the wheel rotation speed of the wheel supporting the leftmost tool frame and a wheel speed sensor configured to monitor the wheel rotation speed of the wheel supporting the rightmost tool frame.

As previously discussed, each row unit 12 includes a packer wheel rotatably coupled to the packer wheel arm and configured to rotate along the surface of the soil. In certain embodiments, wheel speed sensor(s) 94 may be configured to monitor the rotation speed(s) of at least a portion of the packer wheels. Each wheel speed sensor 94 is communicatively coupled to the controller 78, and each wheel speed sensor 94 is configured to monitor the wheel rotation speed of the respective packer wheel. In FIG. 3, certain connections between wheel speed sensors 94 and the controller 78 are not shown for clarity. The controller 78 is configured to determine the forward speed of the frame 14 at the location of the respective packer wheel based on the wheel rotation speed and the diameter of the respective packer wheel. For example, the wheel speed sensor 94 that monitors rotation of the packer wheel of a row unit 12 coupled to the leftmost tool frame 20 may correspond to the left speed sensor, which monitors the left forward speed, and the wheel speed sensor 94 that monitors rotation of the packer wheel of a row unit 12 coupled to the rightmost tool frame 20 may correspond to the right speed sensor, which monitors the right forward speed. As previously discussed, the controller 78 is configured to determine the forward speed differential based on feedback from the left speed sensor and the right speed sensor (e.g., by determining the difference between the left forward speed and the right forward speed). Furthermore, in certain embodiments, the controller 78 may determine the forward speed of the agricultural seeding implement 10 (e.g., along the direction of travel 22) based on feedback from the wheel speed sensor 94 that monitors rotation of the packer wheel of a row unit 12 positioned at or near a lateral center of the frame 14. While the left and/or right speed sensors may include accelerometer(s), inertial measurement unit(s), spatial locating device(s), wheel speed sensor(s), or a combination thereof, in the embodiments disclosed above, in certain embodiments, at least one of the left speed sensor or the right speed sensor may include any other suitable type(s) of sensing device(s) (e.g., alone or in combination with any of the sensing devices disclosed above), such as an optical sensor, a radar sensor, an ultrasonic sensor, other suitable type(s) of sensing device(s), or a combination thereof. Furthermore, as used herein with regard to the speed sensors, “monitoring the forward speed” (e.g., the left forward speed, the right forward speed) refers to monitoring a parameter (e.g., wheel rotation speed, acceleration, velocity, etc.) indicative of the forward speed (e.g., the left forward speed, the right forward speed).

In the illustrated embodiment, the row unit lift control system 76 includes a gyroscopic sensor 96 communicatively coupled to the controller 78. The gyroscopic sensor 96 is configured to monitor a rotational speed of the frame 14 (e.g., about a vertical axis) and to output a sensor signal indicative of the rotational speed. The controller 78 is configured to receive the sensor signal and to determine the forward speed differential based on the rotational speed feedback from the gyroscopic sensor. For example, the controller 78 may determine the forward speed differential based on the rotational speed of the frame 14 and the lateral positions of the outermost row units (e.g., the left outermost row unit(s) and the right outermost row unit(s)).

In certain embodiments, the controller 78 is configured to determine the forward speed differential based on a route of the agricultural seeding implement 10 through the field and the location of the agricultural seeding implement 10 within the field. For example, the route, which includes the path and the forward speed of the agricultural seeding implement 10, may be autonomously or semi-autonomously controlled by a control system (e.g., including the controller 78). The controller 78 may determine the forward speed differential based on the route and the location of the agricultural seeding implement 10 along the path of the route. For example, if the route includes a left turn, the controller 78 may determine the forward speed differential based on a radius of curvature of the left turn and the forward speed of the agricultural seeding implement through the left turn. Furthermore, the controller 78 may determine the location of the agricultural seeding implement 10 within the field based on feedback from a spatial locating device and/or an IMU (e.g., coupled to the frame of the agricultural seeding implement).

In certain embodiments, the controller 78 is configured to determine the forward speed differential based on feedback from one or more sensors (e.g., the left and right speed sensors and/or the gyroscopic sensor) or the route and location of the agricultural seeding implement. However, in other embodiments, the controller 78 is configured to determine the forward speed differential based on feedback from one or more sensors (e.g., the left and right speed sensors and/or the gyroscopic sensor) and the route and location of the agricultural seeding implement. For example, the controller 78 may use a filter (e.g., least squares, Kalman, etc.) to determine the forward speed differential based on multiple data sources. Furthermore, in certain embodiments, the controller 78 is configured to determine the forward speed differential based on feedback from the left and right speed sensors alone or the gyroscopic sensor alone. However, in other embodiments, the controller 78 is configured to determine the forward speed differential based on feedback from the left and right speed sensors and the gyroscopic sensor (e.g., using a filter, such as a least squares or Kalman filter). In addition, in certain embodiments, the controller 78 may determine the forward speed differential based on feedback from a single set of left and right speed sensors (e.g., only the left and right tool frame support wheel sensors, only the left and right packer wheel sensors, only the left and right accelerometers, only the left and right inertial measurement units, or only the left and right spatial locating devices). However, in other embodiments, the controller 78 is configured to determine the forward speed differential based on feedback from multiple sets of left and right speed sensors (e.g., using a filter, such as a least squares or Kalman filter). Furthermore, in certain embodiments, the controller 78 is configured to determine the forward speed differential based on feedback from any sensor(s) disclosed above and/or the route and location of the agricultural seeding implement. In embodiments in which the controller 78 is configured to determine the forward speed differential based on feedback from certain sensor(s), the remainder of the sensor(s) disclosed above may be omitted. Furthermore, in embodiments in which the controller 78 is configured to determine the forward speed differential based on the route and the location of the agricultural seeding implement alone, at least a portion of (e.g., all of) the sensors disclosed above may be omitted.

In certain embodiments (e.g., in embodiments in which the biasing device of each row unit does not include a row unit downforce actuator), in response to determining the forward speed differential is greater than the threshold forward speed differential, the controller 78 may control at least one tool frame actuator 34 to lift the respective tool frame(s) 20 from the working position to the raised transport position. For example, during a tight left turn, the controller 78 may determine the forward speed differential is greater than the threshold forward speed differential, and the left forward speed of the left row units at the left portion 30 of the frame 14 is less than the right forward speed of the right row units at the right portion 32 of the frame 14. In response, the controller 78 may control the tool frame actuator 34 coupled to the leftmost tool frame 20 (e.g., left actuator) to lift the leftmost tool frame 20 from the working position to the raised transport position, thereby disengaging the openers of the row units 12 coupled to the leftmost tool frame 20 from the soil. Furthermore, during a tight right turn, the controller 78 may determine the forward speed differential is greater than the threshold forward speed differential, and the right forward speed of the right row units at the right portion 32 of the frame 14 is less than the left forward speed of the left row units at the left portion 30 of the frame 14. In response, the controller 78 may control the tool frame actuator 34 coupled to the rightmost tool frame 20 (e.g., right actuator) to lift the rightmost tool frame 20 from the working position to the raised transport position, thereby disengaging the openers of the row units 12 coupled to the rightmost tool frame 20 from the soil.

Furthermore, in certain embodiments (e.g., in embodiments in which each tool frame is rigidly coupled to the main support bar), in response to determining the forward speed differential is greater than the threshold forward speed differential, the controller 78 may control the row unit downforce actuator 44 of at least one row unit 12 to lift the opener of the row unit 12, such that the blade of the opener disengages the soil. For example, during a tight left turn, the controller 78 may determine the forward speed differential is greater than the threshold forward speed differential, and the left forward speed of left row unit(s) at the left portion of the frame of the agricultural seeding implement is less than the right forward speed of right row unit(s) at the right portion of the frame of the agricultural seeding implement. In response, the controller 78 may control the row unit downforce actuator 44 of each row unit of the left row unit(s) (e.g., left actuator) to lift the respective opener, such that the blade disengages the soil. Furthermore, during a tight right turn, the controller 78 may determine the forward speed differential is greater than the threshold forward speed differential, and the right forward speed of right row unit(s) at the right portion of the frame of the agricultural seeding implement is less than the left forward speed of left row unit(s) at the left portion of the frame of the agricultural seeding implement. In response, the controller 78 may control the row unit downforce actuator 44 of each row unit of the right row unit(s) (e.g., right actuator) to lift the respective opener, such that the blade disengages the soil.

While the controller 78 is configured to control the tool frame actuators 34 or the row unit downforce actuators 44 in the embodiments disclosed above, in certain embodiments, the controller may be configured to control both the tool frame actuators 34 and the row unit downforce actuators 44 based on the forward speed differential. Furthermore, while control of the outermost tool frames and row units is disclosed above, in certain embodiments, inner tool frame(s) and/or inner row unit(s) may also be controlled. For example, in response to determining the forward speed differential is greater than a first threshold forward speed differential (e.g., threshold forward speed differential), the controller may control at least one actuator to lift the slower of the outer left row unit(s) (e.g., the row units coupled to the leftmost tool frame) or the outer right row unit(s) (e.g., the row units coupled to the rightmost tool frame). In addition, in response to determining the forward speed differential is greater than a second threshold forward speed differential, which is greater than the first threshold forward speed differential, the controller may control multiple actuators to lift the slower of the outer and inner left row unit(s) (e.g., the row units coupled to the left tool frames) or the outer and inner right row unit(s) (e.g., the row units coupled to the right tool frame). In certain embodiments, the control resolution of the row unit lift control system may be at the tool frame level (e.g., in embodiments including the tool frame actuators). In addition, in certain embodiments, the control resolution of the row unit lift control system may be at the individual row unit level (e.g., in embodiments in which each row unit includes a downforce actuator). For example, as the forward speed differential increases above the threshold forward speed differential, the controller may progressively control the row unit downforce actuators to lift the openers of the respective row units along a laterally inward direction (e.g., from the outermost row unit(s) to the innermost row unit(s)). Furthermore, while lifting the row units with tool frame actuators and row unit downforce actuators is disclosed above, in certain embodiments, the row units may be lifted with any other suitable actuators (e.g., alone or in combination with the tool frame actuators and/or the row unit downforce actuators), such as packer wheel actuators, tool frame wheel actuators, etc.

Furthermore, in response to determining the forward speed differential is not greater than the threshold forward speed differential (e.g., less than or equal to the threshold forward speed differential), the controller may control the actuator(s) to lower the previously lifted row unit(s). For example, the controller may store penetration depth(s) of the opener(s) of the row unit(s) before lifting the row unit(s), and the controller may lower the row unit(s) to reestablish the stored penetration depth(s) of the opener(s). In addition, in certain embodiments in which the actuator(s) include hydraulic cylinder(s), the controller may be configured to store fluid pressure(s) within the hydraulic cylinder(s) before lifting the row unit(s) and to return the hydraulic cylinder(s) to the stored fluid pressure(s) to reestablish the penetration depth(s) of the opener(s). In certain embodiments, the controller 78 is configured to terminate operation of metering system(s) that provide the agricultural product to the row unit(s) being raised, thereby substantially reducing or eliminating deposition of the agricultural product on the surface of the field or at an undesirable depth within the soil. In such embodiments, the controller 78 is also configured to initiate operation of the metering system(s) as the row unit(s) are lowered or after the row unit(s) are lowered to resume depositing the agricultural product within the soil at the desired depth. Furthermore, in certain embodiments, the controller 78 is configured to instruct the user interface 84 to present information to the operator indicative of the position of the row units (e.g., whether each row unit is raised or lowered, whether each group of row units is raised or lowered). For example, the controller 78 may instruct the user interface 84 to present a visual indication on the display 86 indicative of whether each row unit or group of row units is raised or lowered. In addition, the controller 78 may be configured to instruct the user interface 84 to present an indication (e.g., on the display 86) in response to determining the forward speed differential is greater than the threshold forward speed differential. Each group of row units includes multiple row units that may be raised and lowered together. For example, the row units coupled to each tool frame may form a group, the row units configured to receive agricultural product from a common header may form a group, row units with row unit downforce actuators having hydraulic cylinders fluidly coupled to a common valve block may form a group, other suitable combinations of row units may form a group, or a combination thereof.

In certain embodiments, the controller 78 is configured to determine a side load on the opener of at least one row unit 12 of the agricultural seeding implement 10 (e.g., each row unit 12 of the agricultural seeding implement 10). In addition, the controller 78 is configured to control at least one actuator (e.g., the tool frame actuator(s) 34 and/or the row unit downforce actuator(s) 44) to lift at least one row unit in response to determining the side load is greater than a threshold side load. For example, during a turn, movement of the agricultural seeding implement 10 through the field may cause a side load to be applied to opener(s) of one or more row units 12. The side load is a load on the opener along a lateral axis 98 (e.g., perpendicular to the direction of travel 22). The threshold side load may be selected based on a lateral load rating of the openers (e.g., 20 percent below the lateral load rating, 30 percent below the lateral load rating, 40 percent below the lateral load rating, 50 percent below the lateral load rating, etc.). Lifting the row unit(s) having opener(s) experiencing a side load greater than the threshold side load may reduce the stress on the opener(s), thereby increasing the longevity of the opener(s).

In certain embodiments, the row unit lift control system 76 includes a lateral speed sensor 100 communicatively coupled to the controller 78. The lateral speed sensor 100 is configured to output a sensor signal indicative of the lateral speed of the agricultural seeding implement 10 (e.g., speed along the lateral axis 98). In addition, the controller 78 is configured to receive the sensor signal and to determine the side load based on feedback from the lateral speed sensor 100. The lateral speed sensor 100 may include any suitable type(s) of sensing device(s) configured to monitor the lateral speed of the agricultural seeding implement 10. For example, the lateral speed sensor 100 may include an accelerometer configured to monitor acceleration (e.g., along the lateral axis 98). The controller 78 may determine the lateral speed by repeatedly sampling the acceleration at time intervals. Furthermore, in certain embodiments, the lateral speed sensor 100 may include an IMU configured to monitor the position and velocity of the agricultural seeding implement 10 based on linear and/or angular acceleration(s). In addition, in certain embodiments, the lateral speed sensor 100 may include a spatial locating device (e.g., GPS receiver, etc.). The spatial locating device is configured to monitor the position and velocity of the agricultural seeding implement 10 based on signals from spatial locating (e.g., GPS) satellites. As used herein with regard to the lateral speed sensor, “monitoring the lateral speed” refers to monitoring a parameter (e.g., acceleration, velocity, etc.) indicative of the lateral speed. The controller 78 is configured to determine the side load(s) on the opener(s) based at least in part on the lateral speed of the agricultural seeding implement 10 (e.g., in combination with the penetration depth of the opener(s) into the soil, the density of the soil, etc.). In the illustrated embodiment, the lateral speed sensor 100 is an independent sensor. However, in other embodiments, the lateral speed sensor may correspond to one of the left speed sensor or the right speed sensor (e.g., in embodiments in which the left speed sensor or the right speed sensor is configured to monitor a lateral speed of the agricultural seeding implement). While the lateral speed sensor may include an accelerometer, an inertial measurement unit, a spatial locating device, or a combination thereof, in the embodiments disclosed above, in certain embodiments, the lateral speed sensor may include any other suitable type(s) of sensing device(s) (e.g., alone or in combination with any of the sensing devices disclosed above), such as an optical sensor, a radar sensor, an ultrasonic sensor, other suitable type(s) of sensing device(s), or a combination thereof.

Furthermore, in certain embodiments, the controller 78 is configured to determine the lateral speed based on a route of the agricultural seeding implement 10 through the field and the location of the agricultural seeding implement 10 within the field. For example, the route, which includes the path and the forward speed of the agricultural seeding implement 10, may be autonomously or semi-autonomously controlled by a control system (e.g., including the controller 78). The controller 78 may determine the lateral speed based on the route and the location of the agricultural seeding implement 10 along the path of the route. As previously discussed, the controller 78 is configured to determine the side load(s) on the opener(s) based at least in part on the lateral speed of the agricultural seeding implement 10 (e.g., in combination with the penetration depth of the opener(s) into the soil, the density of the soil, etc.).

In the illustrated embodiment, the row unit lift control system 76 includes a force sensor 74 coupled to the shank of the opener of each row unit 12, and each force sensor 74 is communicatively coupled to the controller 78. In FIG. 3, certain connections between row unit force sensors 74 and the controller 78 are not shown for clarity. As previously discussed, each force sensor 74 is configured to output a force signal indicative of the side load applied to the opener (e.g., the shank of the opener), and the controller is configured to receive the force signal and to determine the side load based on the feedback from the force sensor 74. For example, the controller 78 may determine the side load on the opener of each row unit based on feedback from the respective force sensor 74, and the controller 78 may control the respective row unit downforce actuator 44 to lift the opener, such that the blade disengages the soil, in response to determining the side load is greater than the threshold side load.

In certain embodiments, the controller 78 is configured to determine the side load(s) on the opener(s) of the row unit(s) based on feedback from the lateral speed sensor 100 or the force sensor(s) 74, or based on the route and location of the agricultural seeding implement 10. However, in other embodiments, the controller 78 is configured to determine the side load(s) based on a combination of two or more of feedback from the lateral speed sensor, feedback from the force sensor(s), or the route and location of the agricultural seeding implement. For example, the controller may use a filter (e.g., least squares, Kalman, etc.) to determine the side load(s) based on multiple sources. Furthermore, in certain embodiments, the process of determining the side load and selectively lifting the opener may be performed for each row unit of the agricultural seeding implement (e.g., the control resolution of the lift control system with regard to side load control may be at the individual row unit level). For example, in the illustrated embodiment, a force sensor 74 is coupled to the opener of each row unit 12. Accordingly, for each row unit 12, the controller 78 may control the respective row unit downforce actuator 44 in response to determining the side load on the respective opener is greater than the threshold side load. Furthermore, in certain embodiments, the process of determining the side load may be performed for each row unit, but the process of selectively lifting the opener may be performed for a group of row units. For example, each row unit may not include the row unit downforce actuator, and the controller may control each tool frame actuator to lift the row units coupled to the tool frame in response to determining the side load on the opener of at least one row unit coupled to the tool frame is greater than the threshold value (e.g., the control resolution of the lift control system with regard to side load control may be at the tool frame level). In such embodiments, force sensor(s) may only be coupled to the opener(s) of a portion of the row units (e.g., a single row unit) coupled to each tool frame. In addition, in certain embodiments, the process of determining the side load and selectively lifting the row units may be performed for all of the row units collectively. For example, the controller may determine the side load based on feedback from the lateral speed sensor, and the controller may control all of the tool frame actuators together to lift all of the row units in response to determining the side load is greater than the threshold side load (e.g., the control resolution of the lift control system with regard to side load control may be at the agricultural seeding implement level). While lifting the row units with tool frame actuators and row unit downforce actuators is disclosed above, in certain embodiments, the row units may be lifted with any other suitable actuators (e.g., alone or in combination with the tool frame actuators and/or the row unit downforce actuators), such as packer wheel actuators, tool frame wheel actuators, etc.

In certain embodiments (e.g., in embodiments in which the controller is configured to determine the side load based on feedback from the lateral speed sensor), the controller is configured to control the actuator(s) to lower the row unit(s) in response to determining the side load is not greater than the threshold side load (e.g., less than or equal to the threshold side load). Furthermore, in certain embodiments, the controller is configured to control the actuator(s) to lower the row unit(s) after a duration (e.g., a duration sufficient to complete a turn). In certain embodiments, the controller is configured to store penetration depth(s) of the opener(s) of the row unit(s) before lifting the row unit(s) and to lower the row unit(s) to reestablish the stored penetration depth(s) of the opener(s). In addition, in certain embodiments in which the actuator(s) include hydraulic cylinder(s), the controller may be configured to store fluid pressure(s) within the hydraulic cylinder(s) before lifting the row unit(s) and to return the hydraulic cylinder(s) to the stored fluid pressure(s) to reestablish the penetration depth(s) of the opener(s). In certain embodiments, the controller 78 is configured to terminate operation of metering system(s) that provide the agricultural product to the row unit(s) being raised, thereby substantially reducing or eliminating deposition of the agricultural product on the surface of the field or at an undesirable depth within the soil. In such embodiments, the controller 78 is also configured to initiate operation of the metering system(s) as the row unit(s) are lowered or after the row unit(s) are lowered to resume depositing the agricultural product within the soil at the desired depth. Furthermore, in certain embodiments, the controller 78 is configured to instruct the user interface 84 to present information to the operator indicative of the position of the row units (e.g., whether each row unit is raised or lowered, whether each group of row units is raised or lowered). For example, the controller 78 may instruct the user interface 84 to present a visual indication on the display 86 indicative of whether each row unit or group of row units is raised or lowered. In addition, the controller 78 may be configured to instruct the user interface 84 to present an indication (e.g., on the display 86) in response to determining the side load is greater than the threshold side load (e.g., for each row unit, for each group of row units, for all of the row units, etc.). While the controller 78 of the row unit lift control system 76 is configured to control actuator(s) to lift row unit(s) based on the forward speed differential and the side load on opener(s) in the illustrated embodiment, in certain embodiments, the controller may be configured to only control actuator(s) to lift row unit(s) based on the forward speed differential, or the controller may be configured to only control actuator(s) to lift row unit(s) based on the side load on opener(s).

In certain embodiments, the controller 78 may disable automatic control of the actuator(s) based on feedback from the user interface 84. For example, the user interface 84 may receive input from the operator indicative of activation of automatic control of the actuator(s) (e.g., by engaging a master switch), and the user interface 84 may output a control signal to the controller 78 indicative of the instructions. The controller 78, in turn, may engage automatic control of the actuator(s) as disclosed above. In addition, the user interface 84 may receive input from the operator indicative of deactivation of automatic control of the actuator(s) (e.g., by disengaging the master switch), and the user interface 84 may output a control signal to the controller 78 indicative of the instructions. The controller 78, in turn, may disable automatic control of the actuator(s). Furthermore, in certain embodiments, the operator may provide an input to the user interface indicative of instructions to override an automatic control action, and the user interface may output a control signal to the controller indicative of the instructions. The controller, in turn, may terminate the automatic control action based on the operator input.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A row unit lift control system for an agricultural seeding implement, comprising a controller comprising a processor and a memory, wherein the controller is configured to:
determine a forward speed differential between a left forward speed of one or more left row units positioned at a left portion of a frame of the agricultural seeding implement and a right forward speed of one or more right row units positioned at a right portion of the frame of the agricultural seeding implement; and
control at least one actuator of the agricultural seeding implement to lift a slower of the one or more left row units or the one or more right row units in response to determining the forward speed differential is greater than a threshold forward speed differential.

2. The row unit lift control system of claim 1, wherein the controller is configured to determine the forward speed differential based on feedback from a left speed sensor and a right speed sensor.

3. The row unit lift control system of claim 2, wherein each of the left speed sensor and the right speed sensor comprises a wheel speed sensor, an accelerometer, an inertial measurement unit, a spatial locating device, or a combination thereof.

4. The row unit lift control system of claim 1, wherein the controller is configured to determine the forward speed differential based on feedback from a gyroscopic sensor.

5. The row unit lift control system of claim 1, wherein the controller is configured to determine the forward speed differential based on a route of the agricultural seeding implement through a field and a location of the agricultural seeding implement within the field.

6. The row unit lift control system of claim 1, wherein the controller is configured to:
determine a side load on an opener of at least one row unit of the agricultural seeding implement; and
control the at least one actuator, at least one additional actuator of the agricultural seeding implement, or a combination thereof, to lift the at least one row unit of the agricultural seeding implement in response to determining the side load is greater than a threshold side load.

7. The row unit lift control system of claim 6, wherein the controller is configured to determine the side load based on feedback from a lateral speed sensor, a force sensor coupled to the opener of the at least one row unit, or a combination thereof.

8. The row unit lift control system of claim 1, wherein the at least one actuator comprises a tool frame actuator, a row unit downforce actuator, or a combination thereof.

9. A row unit lift control system for an agricultural seeding implement, comprising:
at least one left actuator configured to lift one or more left row units of the agricultural seeding implement positioned at a left portion of a frame of the agricultural seeding implement;
at least one right actuator configured to lift one or more right row units of the agricultural seeding implement positioned at a right portion of the frame of the agricultural seeding implement; and
a controller communicatively coupled to the at least one left actuator and to the at least one right actuator, wherein the controller comprises a processor and a memory, and the controller is configured to:
determine a forward speed differential between a left forward speed of the one or more left row units and a right forward speed of the one or more right row units; and
control the at least one left actuator to lift the one or more left row units in response to determining the forward speed differential is greater than a threshold forward speed differential and the left forward speed is less than the right forward speed, and control the at least one right actuator to lift the one or more right row units in response to determining the forward speed differential is greater than the threshold forward speed differential and the right forward speed is less than the left forward speed.

10. The row unit lift control system of claim 9, comprising:
a left speed sensor communicatively coupled to the controller, wherein the left speed sensor is configured to monitor the left forward speed; and
a right speed sensor communicatively coupled to the controller, wherein the right speed sensor is configured to monitor the right forward speed;
wherein the controller is configured to determine the forward speed differential based on feedback from the left speed sensor and the right speed sensor.

11. The row unit lift control system of claim 10, wherein each of the left speed sensor and the right speed sensor comprises a wheel speed sensor, an accelerometer, an inertial measurement unit, a spatial locating device, or a combination thereof.

12. The row unit lift control system of claim 9, comprising a gyroscopic sensor communicatively coupled to the controller, wherein the controller is configured to determine the forward speed differential based on feedback from the gyroscopic sensor.

13. The row unit lift control system of claim 9, wherein the controller is configured to determine the forward speed differential based on a route of the agricultural seeding implement through a field and a location of the agricultural seeding implement within the field.

14. The row unit lift control system of claim 9, wherein the controller is configured to:
determine a side load on an opener of at least one row unit of the agricultural seeding implement; and
control the at least one left actuator, the at least one right actuator, at least one additional actuator of the agricultural seeding implement, or a combination thereof, to lift the at least one row unit of the agricultural seeding implement in response to determining the side load is greater than a threshold side load.

15. The row unit lift control system of claim 14, comprising:
a lateral speed sensor communicatively coupled to the controller, wherein the controller is configured to determine the side load based on feedback from the lateral speed sensor;
a force sensor coupled to the opener of the at least one row unit and communicatively coupled to the controller, wherein the controller is configured to determine the side load based on feedback from the force sensor; or
a combination thereof.

16. The row unit lift control system of claim 9, wherein each of the at least one left actuator and the at least one right actuator comprises a tool frame actuator, a row unit downforce actuator, or a combination thereof.

17. A row unit lift control system for an agricultural seeding implement, comprising a controller comprising a processor and a memory, wherein the controller is configured to:
determine a side load on an opener of at least one row unit of the agricultural seeding implement; and
control the at least one actuator to lift the at least one row unit of the agricultural seeding implement in response to determining the side load is greater than a threshold side load.

18. The row unit lift control system of claim 17, wherein the controller is configured to determine the side load based on feedback from a lateral speed sensor.

19. The row unit lift control system of claim 17, wherein the controller is configured to determine the side load based on feedback from a force sensor coupled to the opener of the at least one row unit.

20. The row unit lift control system of claim 17, wherein the at least one actuator comprises a tool frame actuator, a row unit downforce actuator, or a combination thereof.
